(19) United States
(12) Patent Application Publication
(10) Pub. No.: US 2026/0081804 A1
(43) Pub. Date: Mar. 19, 2026

(54) DUAL CHANNEL CONFERENCE RECORDINGS

(71) Applicant: Twilio Inc., San Francisco, CA (US)

(72) Inventors: Timothy Eggerding, Oakland, CA (US); Tim Chen, San Francisco, CA (US); Miguel Paris Diaz, San Francisco, CA (US); Yilin Gan, San Ramon, CA (US); Vien-An Nguyen, Pleasanton, CA (US); Ihor Yuvchenko, San Bruno, CA (US)

(21) Appl. No.: 18/885,838

(22) Filed: Sep. 16, 2024

(51) Int. Cl. H04L 12/18; H04L 65/65

(52) U.S. Cl. CPC H04L 12/1831; H04L 65/65

(57) ABSTRACT

Methods and systems for implementing dual-channel recordings are disclosed. One or more real-time communication streams are received from one or more participants in a conference. Each of the one or more real-time communication streams are independently forked to a recording media sink configured to process and store the one or more real-time communication streams. Each of the one or more real-time communication streams is converted into a format that encapsulates each stream with one or more metadata items. The one or more metadata items are usable for synchronizing the one or more real-time communication streams. A multi-track recording is made accessible via an application programming interface (API) to one or more downstream tools for further processing or analysis at a conclusion of the conference. The multi-track recording composed by synchronizing the one or more real-time communication streams based on the one or more metadata items.

### TECHNICAL FIELD

The disclosed subject matter relates generally to the technical field of telecommunications and, in one specific embodiment, to methods and systems for recording individual audio streams of each participant in a conference call and then composing them into a dual-channel recording.

### BACKGROUND

In digital conferencing systems, the quality of audio recordings is crucial for effective communication, especially in settings involving multiple participants. Traditionally, conference audio has been captured in mono-channel format, where all voices are mixed into a single track. This method often results in recordings where it is difficult to distinguish individual speakers, which can hinder clarity and understanding.

### BRIEF DESCRIPTION OF THE DRAWINGS

Some embodiments are illustrated by way of example and not limitation in the figures of the accompanying drawings.

FIG. 1 is a schematic diagram illustrating an example of a cloud-based system architecture within which the present invention may be implemented.

FIG. 2 is a block diagram illustrating an example architecture corresponding to the service(s) 120 of FIG. 1.

FIG. 3 is a block diagram depicting an example method for implementing dual-channel conference recordings.

FIG. 4 is a block diagram depicting an example method of recording an individual media stream.

FIG. 5 is an interaction diagram that outlines an example sequence of operations and interactions between various system components when a participant joins a conference, causing the initiation of a recording track.

FIG. 6 is an interaction diagram that outlines an example sequence of operations and interactions between various system components when a participant exits a conference, causing the termination of their individual recording track.

FIG. 7 is a diagram depicting an example timeline of a conference.

FIG. 8 is a block diagram depicting an example of how media is transmitted and recorded from the architectural perspective.

FIG. 9 is a block diagram depicting a resulting composition from one or more methods described herein being applied to the timeline and events described with respect to FIG. 7.

FIG. 10 is a block diagram outlining example architectural changes that may be implemented to transition from a dual-channel to a multi-channel recording system.

FIG. 11 is a block diagram of an example mobile device that may be used to access or interact with the system and services described herein.

FIG. 12 is a block diagram of an example computer system, representing a machine within which instructions for causing the machine to perform any one or more of the methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

The disclosed methods and systems introduce a sophisticated approach to managing and processing real-time communication streams (e.g., audio streams) in conference calls, addressing several technical challenges inherent in prior art systems. Traditional conference recording systems typically mix all participant audio into a single track, which can complicate audio analysis tasks such as transcription and voice recognition, especially in scenarios with multiple simultaneous speakers. This mixing process often results in a loss of individual voice clarity and makes it difficult to isolate speech for processing.

The disclosed methods and systems offer a solution by recording each participant's stream independently (e.g., using Real-Time Transport Protocol (RTP) for the transmission of audio data). Each stream is allocated its own port, ensuring that the data remains distinct and manageable throughout the recording process. To handle the synchronization challenges that arise from managing multiple independent streams, the system employs a technique for encapsulating communication packets along with corresponding metadata, such as precise timestamps (e.g., using the GStreamer Data Protocol (GDP). These timestamps may then be used for accurate alignment of streams during a composition phase, ensuring that the audio playback reflects the true sequence of spoken words as they occurred in real-time.

In example embodiments, the disclosed methods and systems address the issue of jitter and latency variability, which are common in networked audio communications. The implementation includes a de-jittering process that adjusts the timing of audio packets based on their timestamps before they are processed and stored. This adjustment helps to maintain the quality and/or coherence of the streams, as it prevents the audio glitches typically caused by packet timing discrepancies.

The serialized streams may be stored in a cloud-based storage solution (e.g., AWS S3), in their format (e.g., GDP format). This method of storage not only secures the data but also facilitates easy access and retrieval for further processing. When the conference concludes, a composition process is initiated, where the individual files are fetched and merged into a dual-channel recording. This dual-channel format is particularly beneficial for applications requiring detailed audio analysis, such as advanced voice intelligence systems, which can perform more effectively when they can process streams from individual speakers separately.

The disclosed dual-channel conference recording system and methods are configured to enhance the functionality and/or effectiveness of various voice intelligence systems, while also providing robust capabilities for users interested in developing their own transcription services.

Automated transcription services, for instance, may gain a substantial accuracy boost from dual-channel recordings. These services can more reliably transcribe the speech of individual participants, even in scenarios where multiple speakers overlap or speak in quick succession, by isolating each speaker's audio. Voice analytics platforms may also benefit, as they can provide more detailed analyses—such as sentiment analysis or emotion detection—on a per-speaker basis, thanks to the clarity of the audio tracks. AI-driven customer support tools, including virtual assistants, may leverage these clear, separated tracks to better parse customer queries and provide more accurate responses. Additionally, language learning applications may utilize the separation to give specific feedback on a learner's pronunciation and fluency by comparing their speech directly against an instructor's.

Users may build tailored transcription models that cater to specific needs, such as recognizing specialized terminology or accents (e.g., by training machine learning models on the high-quality, separated audio tracks). Integration with existing communication platforms, like Voice over IP (VoIP) systems or customer relationship management (CRM) software, may allow entities to automate the transcription of calls and meetings, facilitating compliance, training, or record-keeping. This integration ensures data remains within the entity's control, enhancing privacy and security. Moreover, the rich metadata and precise timestamps associated with each track enable sophisticated post-processing capabilities. Users can manipulate these tracks in various ways—merging them for comprehensive transcripts with speaker labels or isolating individual contributions for detailed analysis.

Methods and systems for implementing dual-channel recordings are disclosed. One or more real-time communication streams are received from one or more participants in a conference. Each of the one or more real-time communication streams are independently forked to a recording media sink configured to process and store the one or more real-time communication streams. Each of the one or more real-time communication streams is converted into a format that encapsulates each stream with one or more metadata items. The one or more metadata items are usable for synchronizing the one or more real-time communication streams. A multi-track recording is made accessible via an application programming interface (API) to one or more downstream tools for further processing or analysis at a conclusion of the conference. The multi-track recording composed by synchronizing the one or more real-time communication streams based on the one or more metadata items.

The disclosed systems and methods not only propel commercial voice intelligence applications to new heights of accuracy and functionality but also empower users to create bespoke transcription and analysis tools. This adaptability, combined with improved audio quality, marks a significant advancement over traditional mono-channel recording systems, offering enhanced analytical possibilities and operational efficiencies.

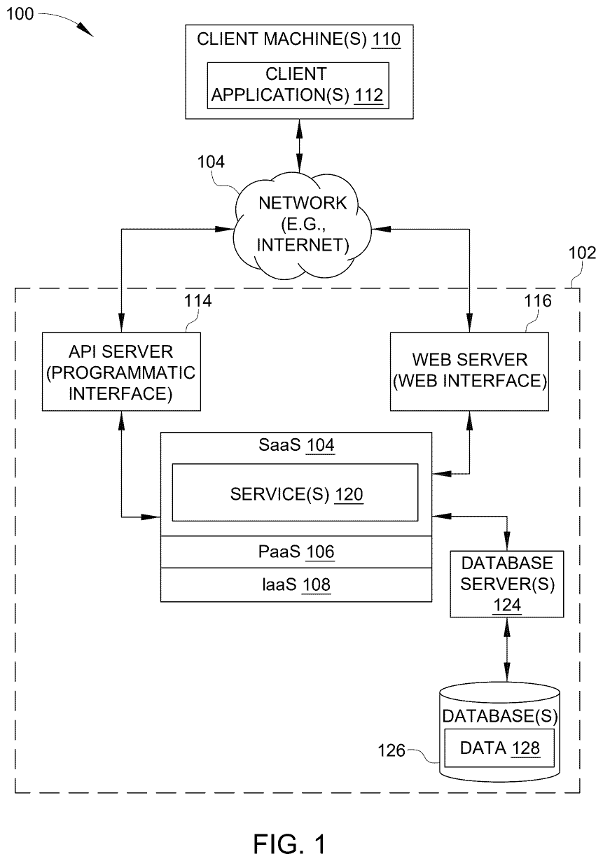

FIG. 1 is a network diagram depicting a system 100 within which various example embodiments may be deployed.

A networked system 102, in the example form of a cloud computing service, such as Microsoft Azure or other cloud service, provides server-side functionality, via a network 104 (e.g., the Internet or Wide Area Network (WAN)) to one or more endpoints (e.g., client machines 110). The figure illustrates client application(s) 112 on the client machines 110. Examples of client application(s) 112 may include a web browser application, such as the Internet Explorer browser developed by Microsoft Corporation of Redmond, Washington or other applications supported by an operating system of the device, such as applications supported by Windows, iOS or Android operating systems.

An API server 114 and a web server 116 are coupled to, and provide programmatic and web interfaces respectively to, one or more software services, which may be hosted on a software-as-a-service (SaaS) layer or platform 104. The SaaS platform may be part of a service-oriented architecture, being stacked upon a platform-as-a-service (PaaS) layer 106 which, may be, in turn, stacked upon a infrastructure-as-a-service (IaaS) layer 108 (e.g., in accordance with standards defined by the National Institute of Standards and Technology (NIST)).

While the applications (e.g., service(s)) 120 are shown in the figure to form part of the networked system 102, in alternative embodiments, the applications 120 may form part of a service that is separate and distinct from the networked system 102.

Further, while the system 100 shown in the figure employs a cloud-based architecture, various embodiments are, of course, not limited to such an architecture, and could equally well find application in a client-server, distributed, or peer-to-peer system, for example. The various server applications 120 could also be implemented as standalone software programs. Additionally, although the figure depicts machines 110 as being coupled to a single networked system 102, it will be readily apparent to one skilled in the art that client machines 110, as well as client applications 112, may be coupled to multiple networked systems, such as payment applications associated with multiple payment processors or acquiring banks (e.g., PayPal, Visa, MasterCard, and American Express).

Web applications executing on the client machine(s) 110 may access the various applications 120 via the web interface supported by the web server 116. Similarly, native applications executing on the client machine(s) 110 may access the various services and functions provided by the applications 120 via the programmatic interface provided by the API server 114. For example, the third-party applications may, utilizing information retrieved from the networked system 102, support one or more features or functions on a website hosted by the third party. The third-party website may, for example, provide one or more promotional, marketplace or payment functions that are integrated into or supported by relevant applications of the networked system 102.

The server application(s) and/or service(s) 120 may be hosted on dedicated or shared server machines (not shown) that are communicatively coupled to enable communications between server machines. The server applications 120 themselves are communicatively coupled (e.g., via appropriate interfaces) to each other and to various data sources, so as to allow information to be passed between the server applications 120 and so as to allow the server applications 120 to share and access common data. The server applications 120 may furthermore access one or more databases 126 via the database servers 124. In example embodiments, various data items are stored in the database(s) 126, such as the system's data items 128. In example embodiments, the system's data items may be any of the data items described herein.

Navigation of the networked system 102 may be facilitated by one or more navigation applications. For example, a search application (as an example of a navigation application) may enable keyword searches of data items included in the one or more database(s) 126 associated with the networked system 102. A client application may allow users to access the system's data 128 (e.g., via one or more client applications). Various other navigation applications may be provided to supplement the search and browsing applications.

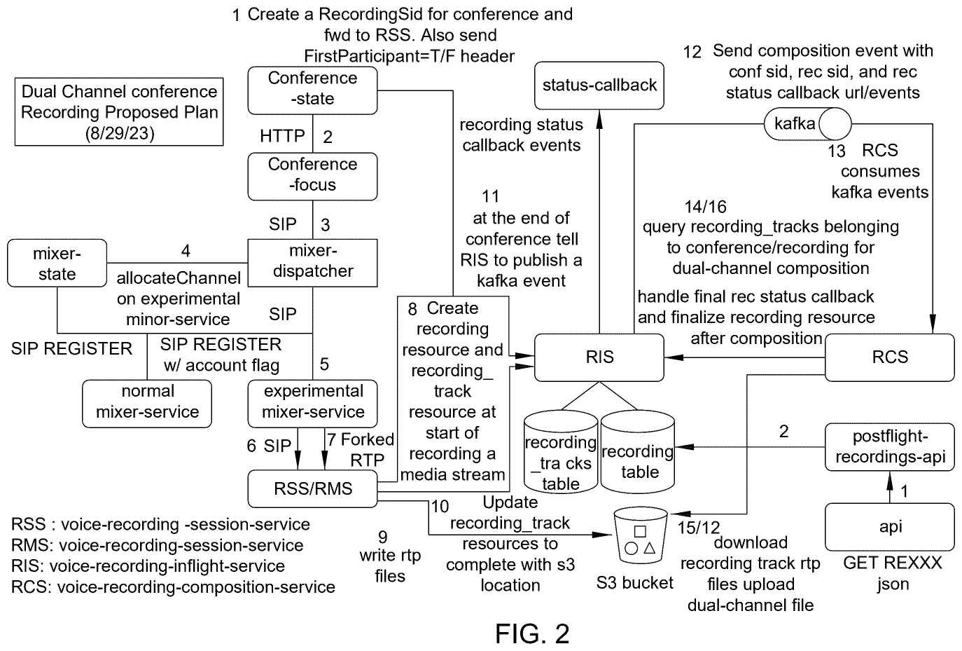

FIG. 2 is a block diagram illustrating an example architecture corresponding to the service(s) 120 of FIG. 1.

In example embodiments, a conference-state component is responsible for the overall management of the conference recording state. It generates a unique RecordingSid for the session, which may be used for tracking and managing the recording process. This component sends a signal to the conference-focus to start the recording (e.g., as indicated by the arrow labeled “Create a RecordingSid for conference and fwd to 1 RSS. Also send FirstParticipant=T/F header.”)

Here, a header, or a piece of metadata, is attached to the data being processed. This header indicates whether the participant whose stream is being handled is the first participant to join the conference call.

FirstParticipant: This is a label or key used in the header of the data packet or stream being sent from one service to another within the system. It specifically identifies whether the participant is the first one who joined the conference.

T/F: This stands for True/False. It is a boolean value that indicates the status of the participant relative to being the first one in the conference. If the value is True (T), it means that the participant is indeed the first one who joined the conference. If the value is False (F), it means the participant is not the first one.

Here, the header is a unit of information that precedes the main data or payload in a data packet. Headers typically contain metadata about the data being sent, such as source, destination, type of data, and other control information that helps the receiving system understand how to process the incoming data.

In example embodiments, when a conference-focus service sends the RTP (Real-time Transport Protocol) streams to a mixer-service for processing, it may include this “FirstParticipant=T/F” header. This may allow the system to recognize and handle the stream of the first participant differently if needed. For example, in scenarios where the audio of the first participant needs to be processed or stored distinctly from others for reasons such as priority handling, easier retrieval, or specific audio processing requirements, this header provides the necessary information to do so.

This functionality enhances the system's ability to manage and process streams in a conference call environment efficiently, ensuring that audio data is handled appropriately based on the participant's status in the call sequence.

The conference-focus receives this signal and manages the focus of the conference, ensuring that the streams are directed appropriately for recording purposes. It then interacts with the mixer-dispatcher, which acts as a routing hub directing the streams to the appropriate mixer service based on the configuration.

The mixer-dispatcher connects one or more mixer services. For dual-channel recording, at least one of the mixer services has the capability to fork streams, which is useful for creating separate audio tracks for each participant.

One or more mixer-services receive the streams and forks each participant's stream, sending these individual streams to the RSS/RMS (Recording Session Service/Recording Media Sink). The RSS manages the session details and ensures that the recording resources are correctly allocated and tracked, while the RMS handles the actual audio data, processing the forked RTP streams.

Connected to the RSS/RMS is the RIS (Recording Inflight Service), which manages the recording tracks'lifecycle. It updates the status of recording tracks, handles any in-progress recording data, and ensures that all recording data is correctly finalized once the recording session ends. The RIS is configured to manage the recording process and interacts with the recording_tracks table and the recordings table. These tables store metadata about what is stored and where, facilitating efficient data management and retrieval.

The RCS (Recording Composition Service) retrieves all the individual GDP files stored by the RMS in the (e.g., AWS S3) bucket, aligns these files based on their timestamps, and/or merges them into a coherent dual-channel recording. This service ensures that the final recording accurately reflects the sequence of the conversation as it occurred.

The postflight-recordings-api is also connected (e.g., via the recordings table). This API manages the retrieval and final processing of the recordings once they are composed. It provides the interface through which the final recordings can be accessed and downloaded, ensuring that users can retrieve the processed recordings efficiently.

Additionally, the RIS is connected to a status-callback component and a messaging system (e.g., Kafka). The status-callback component communicates the status of the recording process to other systems or interfaces that require this information. The messaging system handles messaging and event-driven actions that are part of the recording workflow, ensuring that all components are synchronized and that events are processed in a timely manner.

In summary, the example architecture configured to handle each aspect of the recording process—from capturing individual streams, managing recording sessions, processing and storing audio data, to finally composing and finalizing the dual-channel recording. This system not only improves the quality and flexibility of conference recordings but also ensures that the recordings are managed efficiently and securely, making it a robust solution for modern communication needs.

In example embodiments, each real-time communication stream received from conference participants is independently processed to ensure precise handling and storage. Upon receipt at the mixer service, each stream is duplicated through a sophisticated forking mechanism. This mechanism establishes a dedicated data path for each stream, thereby isolating the handling and processing of individual streams. One copy of each forked stream is directed towards ongoing live conference mixing, while the other is routed to a designated recording media sink. This ensures that live conference interactions are maintained without interruption, while simultaneously preserving a separate copy for recording purposes.

At the recording media sink, separate processing queues are maintained for each forked stream. This arrangement prevents data loss and ensures the integrity of the recorded data by isolating the streams from each other, thereby avoiding any potential interference or data corruption that could arise from processing multiple streams together. Each stream is then converted into a format that encapsulates the stream with comprehensive metadata. This metadata may include precise timestamps, which indicate the exact timing of each audio packet within the stream, and/or participant identifiers, which uniquely associate each stream with a corresponding participant. Additionally, audio quality metrics may be included to assess the clarity and volume levels of each stream.

The synchronization of the streams may be managed using a multi-faceted approach. Firstly, the timestamps of each stream may be aligned to a unified timeline based on the earliest received audio packet among all streams. This alignment ensures temporal consistency across the multi-track recording. Secondly, playback speed adjustments may be made for individual streams to compensate for any discrepancies in audio packet arrival times, which may result from network latency or jitter. These adjustments may help maintain the audio quality and coherence of the final recording.

Furthermore, the metadata containing participant identifiers may be used to maintain the chronological order of speech contributions from each participant. This ensures that the sequence of conversation events is accurately preserved in the final recording. Advanced algorithms are employed to analyze the metadata and perform these synchronization tasks, ensuring that the audio playback reflects the true sequence of spoken words as they occurred in real-time.

The multi-track recording, thus composed, may be made accessible via an application programming interface (API) to downstream tools for further processing or analysis, providing a robust and detailed record of the conference proceedings. This comprehensive approach to handling, processing, and synchronizing streams in a conferencing environment not only enhances the functionality of the system but also ensures the production of high-quality, analytically valuable recordings.

In example embodiments, the system is equipped with advanced capabilities to manage and handle periods of silence effectively. Silence within a conference can occur due to various reasons such as pauses in speech, participants muting their microphones, or network-induced losses. To address these challenges, the system incorporates several key technologies and methodologies.

Firstly, the system utilizes a sophisticated dejittering process that adjusts the timing of audio packets based on their timestamps before they are processed and stored. This adjustment may be used for handling silence effectively as it helps in aligning audio packets with varying arrival times, which is common in network communications. By ensuring that packets are synchronized, the system can maintain audio continuity and minimize the impact of silence caused by jitter.

Moreover, the system may employ packet loss concealment techniques to manage the silence that occurs due to missing audio packets. This is may be helpful in maintaining the quality of the conference recording. The system predicts and synthesizes plausible audio portions to fill in the gaps created by lost packets, thereby ensuring that the recording remains coherent and continuous even when some data is missing.

Additionally, the system leverages a protocol, such as GDP, for storing streams. The protocol allows for the encapsulation of raw streams along with extensive metadata, including precise timing information. This metadata may be useable in reconstructing the streams during the composition phase of the recording process. By using the timestamps and other related metadata, the system can accurately place silence within the recording where it naturally occurs, preserving the authenticity and integrity of the conversation.

The handling of silence is further refined during the composition phase, where the system aligns and merges individual audio tracks into a dual-channel recording. The synchronization process takes into account the timestamps from the encoded (e.g., GDP-encoded) streams, ensuring that silent portions are accurately represented and maintained in relation to the spoken parts of the conversation. This approach allows the system to produce a final recording that faithfully replicates the live experience of the conference, including the natural pauses and silences that occur during conversations.

Through these integrated processes, the system not only handles silence effectively but also enhances the overall quality and usability of the conference recordings. This capability is useful for applications requiring high-quality audio analysis, such as transcription services, voice analytics, and other voice-driven technologies.”

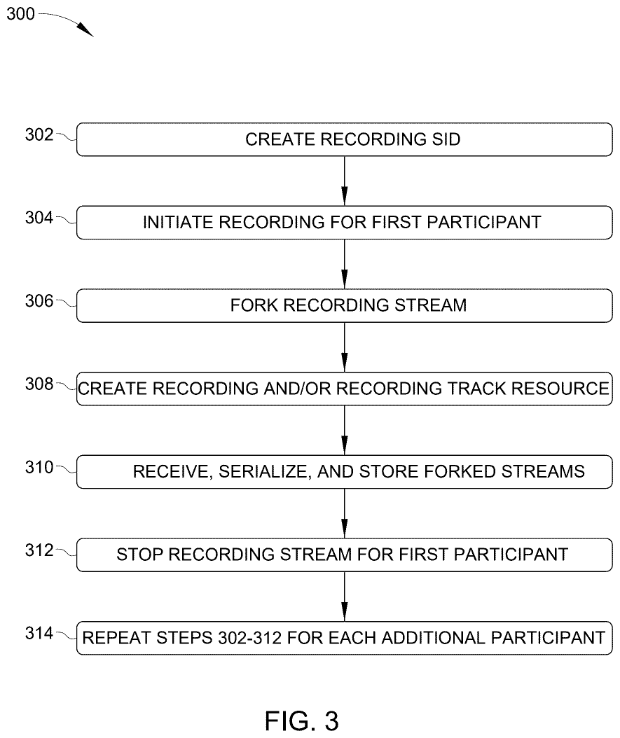

FIG. 3 is a block diagram depicting an example method for implementing dual-channel conference recordings.

To create a dual-channel recording file for a conference, the system may be configured to record all participants'media independently, and then merge all participants'single-track recordings into a dual-channel recording file with proper timing alignment.

In example embodiments, streams from each participant are captured and processed independently. Then they are ultimately composed into a dual-channel recording.

At operation 302, a recording session identifier (SID) is created.

At operation 304, a recording for a first participant is initiated. In example embodiments, a voice-conference-state-service initiates the recording process by creating a unique recording SID (e.g., RecordingSid) for the conference. This service communicates with a voice-conference-focus-service, which is responsible for managing the conference's focus and directing the streams to the appropriate services.

At operation 306, the recording stream is forked. A voice-mixer-service is configured to fork each participant's stream (e.g., RTP stream) rather than mixing them. The forking process is managed by one or more mixer-services equipped with forking capabilities, which allows it to send individual streams to a voice-recording-session-service located in the same region.

At operation 308, a recording resource and/or recording track resource is/are created. The voice-recording-session-service receives the forked streams. It checks if a recording resource already exists for the given RecordingSid. If not, it creates one and ensures that the recording resource is managed correctly throughout the session. This service also interacts with a voice-recording-inflight-service, which is responsible for creating and managing recording track resources with status updates (e.g., in-progress, completed).

At operation 310, the forked streams are received, serialized, and/or stored. Each participant's stream is handled by the voice-recording-media-sink, which receives the forked streams. This component may be configured to add timestamps to the packets, a process that ensures synchronization during later composition. The media sink serializes the streams (e.g., using GDP) and stores them in a multi-channel (e.g., AWS S3) bucket designated by the account_sid and recording_session_sid.

At operation 312, the recording stream is stopped for the first participant.

At operation 314, steps 302-312 are repeated for each additional participant.

Once the conference ends, the voice-conference-state-service instructs the voice-recording-inflight-service to publish a composition event (e.g., a Kafka event). This triggers the voice-recording-composition-service to start the process of composing the dual-channel recording. It retrieves the (e.g., GDP) files from bucket, aligns them based on their timestamps, and composes them into a dual-channel recording file. This file is then processed (e.g., trimming, encrypting) and uploaded either to the recording bucket or an external bucket, depending on the configuration.

The final dual-channel recording can then be accessed by users (e.g., through an application programming interface (API), which supports downloading in various formats like WAV or MP3). The system also includes mechanisms for handling retries and monitoring during outages, ensuring robustness and reliability.

Thus, the disclosed dual-channel recording architecture is designed to provide a high degree of control and flexibility in handling streams, significantly improving the quality and utility of conference recordings for advanced processing and analysis applications. This architecture not only supports dual-channel recordings but is also scalable to multi-channel configurations, making it a future-proof solution for evolving audio processing needs.

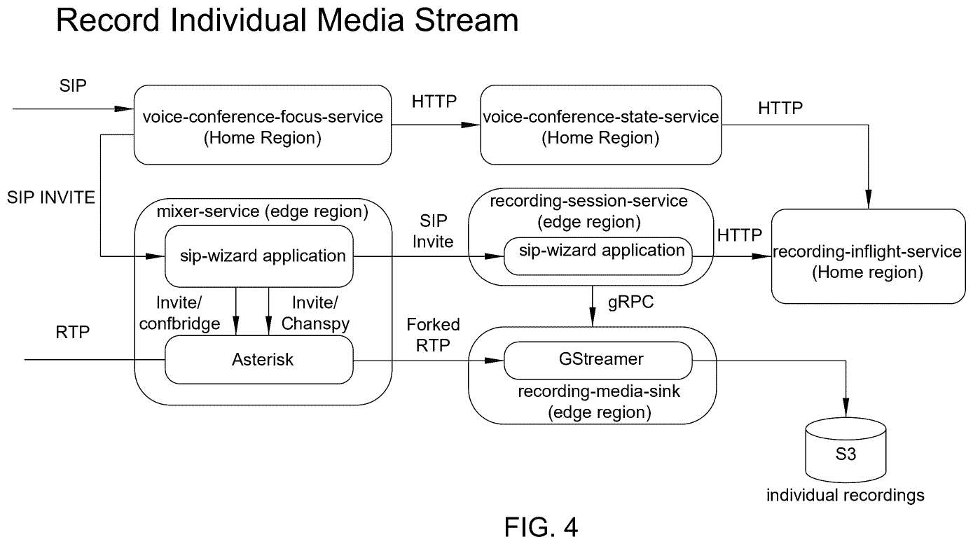

FIG. 4 is a block diagram depicting an example method of recording an individual media stream.

In example embodiments, the process begins with the voice-conference-focus-service located in the Home Region (e.g., a geographical or logical region where the services and data processing for the conference recording system are located). This service is responsible for managing the initiation of the recording process when a participant joins the conference. It sends an INVITE request to the mixer-service in the Edge Region (e.g., a deployment area that is geographically closer to the end-users), which may be helpful for routing the individual (e.g., RTP) streams to the appropriate recording services. The INVITE includes specific headers, such as “X-Twilio-RecordingSid” and “X-Twilio-ParticipantSid,” which carry metadata about the recording session and participant identity.

Upon receiving the INVITE, the mixer-service acts as a junction that not only manages the audio mixing but also directs the streams to the recording-session-service. This service, also located in the edge region, acts as a gateway to the recording-media-sink, which is tasked with the actual processing of the streams. The recording-media-sink employs a pipeline (e.g., a GStreamer pipeline) to serialize the incoming streams into a particular format (e.g., the GDP format). This serialization may support the inclusion of extensive metadata, such as timestamps and codec information, which may be used for later synchronization and quality processing.

The serialized data is then stored in a bucket (e.g., an AWS S3 bucket), and may be organized under specific directories that correspond to the recording session and participant identifiers. This structured storage approach facilitates efficient data retrieval and management, enabling quick access when the data needs to be composed into a final recording format.

Simultaneously, the recording-inflight-service in the Home Region is configured to help in managing the recording metadata and status updates. For example, it may be configured to help ensure that all recording tracks are correctly logged and their statuses are updated in real-time. This service interacts with the database systems, specifically the recording_tracks table and the recordings table, to maintain a record of all ongoing and completed recordings. These tables store detailed information about each recording track, including start and end times, storage locations, and status flags.

FIG. 4 also highlights the interaction between the mixer-service and the recording-media-sink via the “Forked RTP” arrow, indicating the direct flow of streams (e.g., RTP streams) to the recording-media-sink for processing.

Thus, FIG. 4 provides a granular view of the technical interactions and data flows between various services and components within the architecture. This setup not only ensures high-quality recordings by maintaining the integrity of each participant's audio but also offers the flexibility to process and analyze streams independently or together, depending on the application's needs.

In example embodiments, a voice-conference-state-service will create the recording SID for the conference and pass to a voice-mixer-service. For example, it will provide it to focus to send along in the SIP INVITE forwarding it all the way to RSS. Also if it is the first participant, the FirstParticipant header will be forwarded to RSS.

A first participant's recording request will trigger conference-focus to indicate mixer-service to start recording along with the recording SID.

If a customer has the dual-channel mixer account flag enabled, a mixer-service host with (e.g., RTP) forking capabilities may be used.

A voice-mixer-service may bridge the participant into conference, as well as initiate a SIP session to voice-recording-session-service in the same region and then forks the inbound RTP stream to an allocated port that voice-recording-media-sink is listening to, which is managed by voice-recording-session-service.

When the first SIP session to voice-recording-session-service is initiated, voice-recording-session-service will check if the recording resource already exists with the recording SID, and if it doesn't exist, create the recording resource in the database. If the FirstParticipant header is set to true, CallSid will be set to the first participant's call sid. voice-recording-session-service will tell voice-recording-inflight-service to handle the “in-progress” recording status callback if needed.

When the stream starts being recorded, voice-recording-session-service calls voice-recording-inflight-service to create a recording_track resource with status=in-progress and conferenceSid=CFXXX and recordingSid=REXXX.

voice-recording-media-sink receives forked RTP streams for each participant, serializes each stream individually using GDP format (GStreamer Data Protocol) and stores them into the multichannels bucket When the participant leaves, voice-mixer-service stops recording the stream and returns the S3 location to RSS.

When the RTP stream stops being recorded, voice-recording-session-service calls voice-recording-inflight-service to set the recording_track resource's status=completed and set the S3 location of the rtp file.

Additional participants go through the steps above.

Once the conference has ended, voice-conference-state-service will tell voice-recording-inflight-service to publish a composition event (e.g., a Kafka event).

When receiving an event, voice-recording-composition-service will query the recording_tracks belonging to the conference/recording, compose the GDP files into a dual-channel recording, do other processing like trimming, encrypting, etc., upload it to the recording bucket or upload to external bucket. If label composition is not requested then by default the CallSid in the recording resource will be isolated in the first channel (aka the first participant).

After the dual-channel recording is uploaded, voice-recording-composition-service may call voice-recording-inflight-service to perform recording status callbacks and set the recording resource DB status to “completed”.

Once the recording resource is “completed,” the recording can be downloaded by customers and voice-recording-composition-service will also send a message (e.g., a Kafka message) to a topic (e.g., Voice. RecordingEvents), for Voice Intelligence auto-transcribe services.

If users specify to download wav files, twilioproxy-api will get the file from the bucket directly. If customers specify to download mp3 files, twilioproxy-api will call sox to transcode the wav into mp3, and then respond back to the user's request. The squid-api will cache the recording file (wav or mp3), in case the customer fetches the same recording file multiple times, to reduce load to twilioproxy-api.

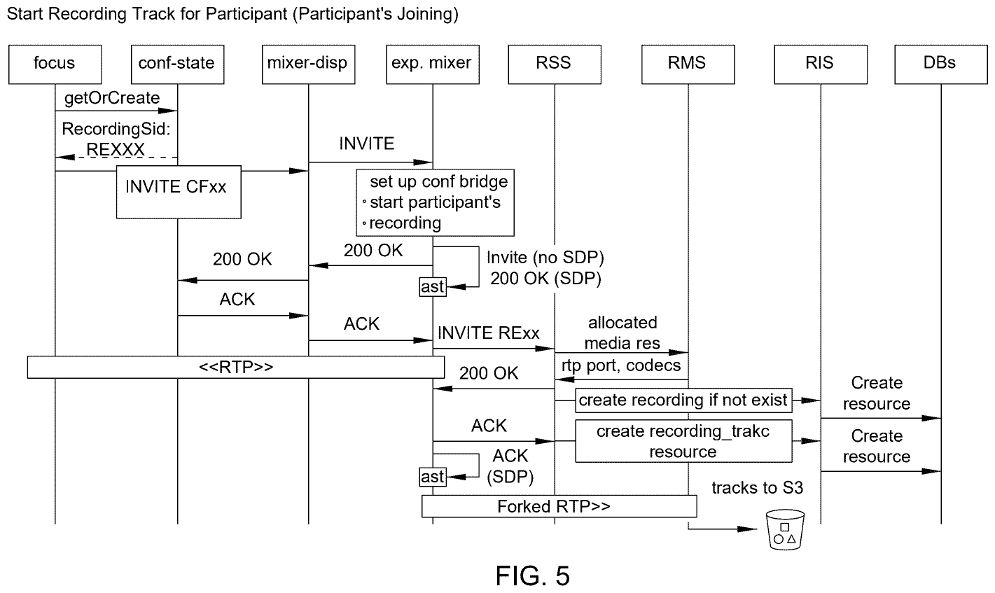

FIG. 5 is an interaction diagram that outlines an example sequence of operations and interactions between various system components when a participant joins a conference, causing the initiation of a recording track. This detailed flow shows how each participant's stream is accurately captured and processed from the moment of their entry into the conference.

The process initiates in the conference-state component located in the Home Region. This component is configured to manage the overall state of the conference. When a participant joins, the conference-state generates or retrieves a unique RecordingSid (Recording Session Identifier), which may be used for uniquely identifying the recording session associated with the conference.

This RecordingSid is then passed to the focus component, also in the Home Region. The focus component is responsible for managing the audio focus within the conference, ensuring that the new participant's stream is correctly directed for recording purposes.

From here, the flow moves to the mixer-dispatcher, which operates across both Home and Edge Regions. The mixer-dispatcher serves as a routing hub. It receives the RecordingSid and instructions from the focus component about handling the new participant's stream. Based on these instructions, it determines whether the stream should be handled by one or more mixer-services, such as one selected for sessions that require recording capabilities.

One or more mixers in the Edge Region then receive the participant's stream. This service is equipped with (e.g., RTP) forking capabilities, allowing it to split the stream. This means it can continue to send one stream to the normal conference mixing process while simultaneously directing a forked stream towards the recording services.

The forked stream is sent to the RSS (Recording Session Service), also located in the Edge Region. The RSS acts as a session manager for the recording, associating the stream with the correct RecordingSid and preparing it for processing.

Following the RSS, the RMS (Recording Media Sink) processes the stream. Located in the Edge Region, the RMS handles the actual data processing of the stream, potentially transforming or packaging it into a suitable format for storage, such as the GDP. This format may be chosen for its ability to preserve essential metadata like timestamps and codec information, which are vital for later synchronization and quality processing.

The processed data and its associated metadata are then managed by the RIS (Recording Inflight Service) in the Home Region. The RIS is responsible for creating and updating the recording_track resource in the database systems. This resource logs detailed information about the recording, such as start time, status, and/or the storage location of the recorded data.

Finally, the DBs (Databases) in the Home Region store all metadata associated with recordings. When the RIS updates or creates a recording_track resource, these changes are reflected in the database. This ensures that all information about the recording session is accurately logged and can be queried or updated as needed.

This flow from the conference-state to the databases ensures that each participant's audio is handled efficiently and accurately from the moment they join, supporting high-quality recording and management of conference streams.

In example embodiments, the voice-conference-state-service will take the responsibility of Creating the Recording Sid to be passed down the flow to voice-recording-session-service which will create the recording resource in the DB; and Signaling that the conference has ended and recording should be ready to be composed by calling to voice-recording-inflight-service to publish an event (e.g., Kafka event) to be consumed by voice-recording-composition-service.

From voice-conference-state-service, voice-conference-focus-service will bring the RecordingSid to voice-mixer-service via init-Invite. voice-mixer-service will join the participant into its mixing session, and fork the participant's media stream to voice-recording-session-service (signal) and voice-recording-media-sink (media), which will record individual participant's media stream.

This media capture workflow is designed to capture the stream as natively as possible on the mixer-service box. In example embodiments, the stream is captured as-is in order to support analyzing the timing of the stream (e.g., to align with other participants_.

Further, voice-recording-media-sink receives the forked stream, serializes packets (e.g., using GDP), and/or progressively uploads the media to a bucket (e.g., AWS S3). Pause/resume and mute can be achieved by detaching and reattaching the stream hook for the affected participants in the recording. Since using serialization timestamping is added to the individual packets, the system can insert silence as needed downstream during composition.

The raw audio data for each track may be stored in a bucket. Since voice-recording-inflight-service manages all the recording tracks resources for a recording session, voice-recording-composition-service will know at the time of the conference ending whether all recording tracks have been uploaded to the bucket. Each home region will use a dedicated bucket to store recording track files. An attribute will indicate which home region the file belongs to, so the voice-recording-media-sink could differentiate it and pick the correct bucket to store.

During a bucket outage, the voice-recording-media-sink may be configured to store recording tracks locally and then re-drive the uploads once the bucket outage is resolved. The voice-recording-media-sink may also be configured provide metrics and monitor to the local storage. In example embodiments, this may allow on-call engineers to expand the fleet and/or the local storage during any bucket outage incident, to avoid exhausting local storage. There may also be retries allowed on the uploading of files, the downloading of files, uploading of the composed dual-channel file, and external bucket uploads.

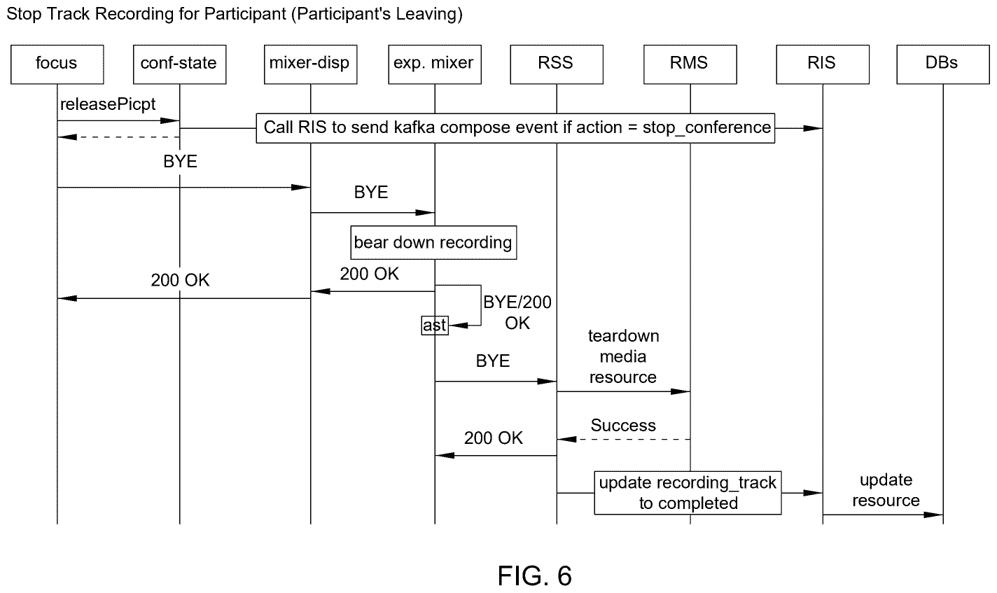

FIG. 6 is an interaction diagram that outlines an example sequence of operations and interactions between various system components when a participant exits a conference, causing the termination of their individual recording track. This flow shows how the system manages the cessation of stream processing and ensures the proper closure and storage of the recording data.

The process initiates with the focus component in the Home Region, which is responsible for managing the audio focus within the conference. When a participant leaves, this component detects the event and initiates the termination process by sending a BYE message to the mixer-dispatcher. The mixer-dispatcher, straddling both the Home and Edge Regions, acts as a routing hub. It receives the BYE message and, recognizing that a participant has left, forwards this message to the mixer service located in the Edge Region.

The mixer service, upon receiving the BYE message, proceeds to tear down the recording for the departing participant. This involves stopping the stream processing for that specific participant and ensuring that no further audio data from this participant is sent to the recording services. Once the mixer has successfully stopped the stream, it sends a confirmation back to the mixer-dispatcher, which then communicates with the RSS (Recording Session Service) also located in the Edge Region.

The RSS is configured to manage the session details for the recording. It receives the notification from the mixer-dispatcher that the participant's stream has been stopped and, in response, sends a signal to the RMS (Recording Media Sink). The RMS is responsible for the actual data processing of the stream. Upon receiving the signal from the RSS, it finalizes the recording of the participant's stream, processes any remaining audio data, and/or ensures that the final pieces of data are correctly stored.

Simultaneously, the RSS sends a message to the RIS (Recording Inflight Service) in the Home Region to indicate that the recording track should be marked as completed. The RIS updates the recording_track resource in the database to reflect this completion. This resource logs detailed information about the recording, such as the end time and the storage location of the recorded data.

Finally, the databases (DBs) in the Home Region store all metadata associated with recordings. When the RIS updates the recording_track resource to indicate completion, these changes are logged in the database. This ensures that all information about the recording session is accurately maintained and can be queried or audited as needed.

This flow from the detection of a participant's departure to the finalization of their recording track ensures that each participant's audio is handled efficiently and accurately, supporting high-quality recording management and data integrity in conference streams.

When the participant leaves the conference or the participant is being held, conference-focus will send BYE to mixer-service to teardown the session. The mixer-service will end the forking dialog as well. The voice-recording-session-service will stop the recording.

In the Hold/Unhold case, when the participant (same ParticipantSid) rejoins the conference mixer, a new RecordingTrack will be created. Mixer-service will follow the same procedure as setting up a normal session.

### RTP/RTCP Port Allocation

The voice-recording-media-sink may be responsible for allocating a free event RTP port (and an odd RTCP port) (e.g., between 10000-20000) on the host to receive RTP packets from voice-mixer-state.

### RTP Serialization

When voice-media-sink-service starts recording, a gstreamer pipeline may be executed to transform incoming RTP to serialized GDP stream to be written to disk.

Gstreamer Pipeline:
udpsrc->rtpbin->gdppay->filesink

GDP or a similar protocol may be used as mechanism to serialize RTP streams (see evaluation doc) because of one or more of the following reasons:

Support inter-stream synchronization due to using UTC.

Compatible with expected future codecs for high-quality like AMR-NB and AMR-WB.

Unique way of serializing, no need to support several muxers.

RTP packets are directly serialized and recorded, so we have the next advantages:

Allow RTP debugging.

Remove load of depayloading on live.

Reduce risks regarding potential future bugs in depayloaders.

We have more margin-action during composition process.

### Conference Announcements

In the conference announcement case, voice-mixer-service may handle the conference announcement as normal and may also fork the RTP to voice-recording-media-sink, with voice-recording-session-service.

The recording of the conference announcement track may follow the same procedure as recording a participant stream. A recording track resource may be created for the same recording session, the streams will be stored in a bucket, and during composition, the stream will be used to generate the dual-channel conference recording. Conference announcements may be in a second channel.

### Compose the Dual-Channel Recording

At the end of a conference, conference-state-service may signal voice-recording-inflight-service to send an event (e.g., a Kafka event) to indicate the end of the conference. voice-recording-composition-service may consume the event and start composing the dual-channel recording.

A voice-recording-composition-service may download all the files (e.g., GDP files) for the conference by using the recording_tracks resources with the same conference sid. Because participants can be held then unheld, voice-recording-composition-service may process multiple GDP files belonging to the same participant.

For each participant, the related files may be composed (e.g., using next Voice composer script, which receives a JSON based configuration as input and performs proper composition applying needed offsets to align all the original streams to generate the final dual channel conference recording in .wav or .mka audio formats).

After the dual-channel recording is composed, the voice-recording-composition-service will handle any further processing like encryption or external bucket and billing and clean-up of the files. The dual-channel recording may be uploaded to the recordings bucket in the correct home region, the recording status may be set to “completed”, and/or recording status callbacks may be sent via voice-recording-inflight-service from voice-recording-composition-service, so users can fetch the recording.

### De-Jittering, Timestamping and Inter-Stream Synchronization

In example embodiments, providing a good quality of experience for users may be important, so the system may be configured to be quite strict regarding proper inter-stream synchronization. For example, the channels of the resulting conference recording may be aligned to be accurate as to what actually happened in the live conference.

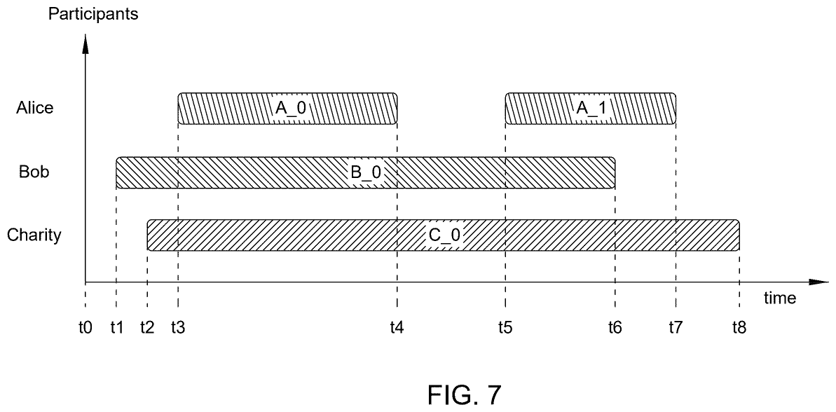

FIG. 7 is a diagram depicting an example timeline of a conference with three participants—Alice, Bob, and Charly. It provides a detailed visual representation of the sequence and timing of events within a conference call. This timeline shows how the recording system captures, processes, and synchronizes each participant's stream to compose a final recording that accurately reflects the live conversation.

The timeline is divided into specific time points labeled from t0 to t8, each representing events in the conference. At t0, the conference begins, setting the stage for participant interactions. Bob is the first to join at t1, initiating his stream which marks the beginning of the recording process for his contributions. Shortly after, at t2, Charly joins the conference, adding a second stream to the mix. The third participant, Alice, joins at t3, introducing her stream into the recording system.

As the conference progresses, key events such as participants leaving and rejoining are marked: Alice temporarily leaves the conference at t4, causing her stream to pause. She rejoins at t5, resuming her stream. Bob permanently leaves the conference at t6, concluding his audio contribution. Alice leaves again at t7, and finally, Charly departs at t8, marking the end of the conference.

Post-conference, the system undertakes the task of composing the recorded streams into a final recording. This composition process is meticulous, aligning each stream's start and stop times to ensure the final recording seamlessly represents the live interaction. The system handles each stream independently, allowing for sophisticated features such as dual-channel or multi-channel recordings where audio from each participant can be isolated or specifically mixed.

This timeline diagram not only serves as a tool for visualizing the dynamic and interactive nature of conference calls but also underscores the complexity involved in accurately capturing and synchronizing multiple streams. It illustrates the advanced capabilities of the recording system, designed to meet precise requirements for stream management and composition in applications that demand high fidelity and detailed audio processing.

The system creates a final composition that is based on one or more of the following considerations:

Each participant joins and unjoins at a different time, so the system needs to store in some way this information in addition to media (voice) itself.

A participant (Alice in our case) can join/unjoin several times the same conference.

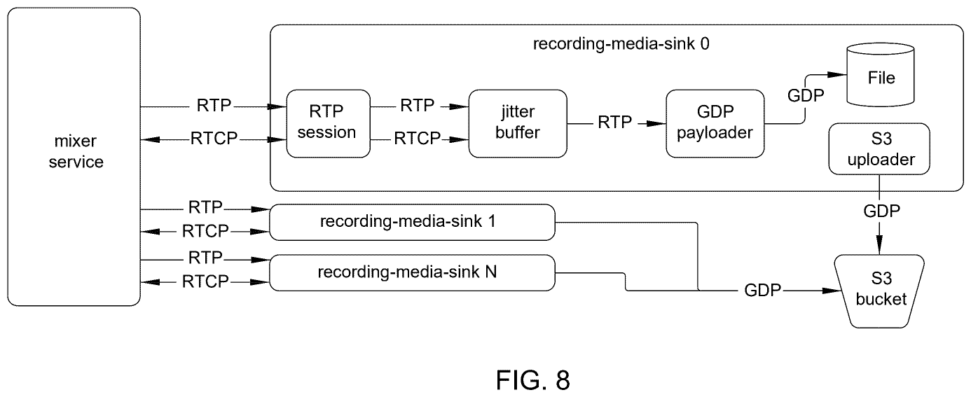

FIG. 8 is a block diagram depicting an example of how media is transmitted and recorded from the architectural perspective. FIG. 8 particularly highlights the connection between the mixer service and the recording media sinks, providing a comprehensive view of the audio processing workflow within the dual-channel conference recording system. This diagram illustrates the flow of audio data through various components of the system, ensuring efficient handling and accurate recording of conference calls.

The mixer service may be strategically positioned within the edge region to minimize latency for conference participants. The mixer service is responsible for receiving individual streams from participants and managing the live mixing of these streams to facilitate real-time communication during the conference. For recording purposes, the mixer service also plays a pivotal role in forking the streams; for example, while it continues to handle the live mixing, it simultaneously sends copies of each participant's stream to the recording infrastructure.

The forked streams are directed from the mixer service to the recording media sinks. These components are configured to perform the initial handling and processing of the recorded audio. Located also within the edge region to maintain low latency, the recording media sinks receive the streams and begin the process of serialization. This involves converting the streams into a format suitable for storage and further processing, typically using a protocol like GDP, which may be chosen for its ability to encapsulate detailed metadata along with the audio data. This metadata is essential for later stages of processing, such as when aligning and synchronizing streams during the composition of the final recording.

The recording media sinks then store the serialized audio data in a designated storage system, such as a bucket. This storage may be structured to facilitate easy access and management of audio data, categorizing files based on the conference session and individual participant identifiers. This organization is allows for efficiently retrieving and processing audio data in subsequent steps.

Following the initial capture and storage by the recording media sinks, the system may involve additional processing steps such as de-jittering, synchronization, and/or composition, handled by other components in the architecture. These processes ensure that the final recording accurately reflects the timing and sequence of the live conference, with all participant audio properly aligned.

This setup not only supports high fidelity in the recordings but also provides the flexibility needed for advanced recording features such as dual-channel or multi-channel outputs.

In example embodiments, each participant is recorded independently, sending the related stream from mixer-service to the recording-media-sink.

Each recording-media-sink performs de-jittering (e.g., using a Jitter Buffer in live in order to set PTS to each RTP based on arrival time, RTCP sender reports and RTP-time).

Forked RTP/RTCP streams from mixer-service can be sent to different recording-media-sink instances, which mean that the PTS of each RMS should be based on a common wall-clock to perform alignment during the composition process. For that we decided to use UTC PTSs based on system clock assuming that there might be a drift depending on the host's clock synchronization because any kind of other synchronization mechanism (eg: NTP protocol between hosts) would have the same issue basically due to the jitter buffer implementation sets PTSs based on the first RTP packet received plus offset based on RTP-time and RTCP sender reports.

Each RTP flow after de-jittering is serialized (e.g., using GDP, which serializes both GStreamer caps (codec details) and GstBuffers) (each GstBuffers contains an RTP packet plus the PTS assigned by the jitter buffer).

With the above considerations, the composition process is able to generate a final audio file, such as by performing one or more of the following operations:

Gather all the independent recorded tracks stored in the bucket in the chosen (e.g., GDP) format.

The first participant joining the conference is isolated in Channel 0.

Rest of the participants are mixed on Channel 1.

Offers with silence are applied to align the original recorded tracks using PTSs based on UTC as wall-clock.

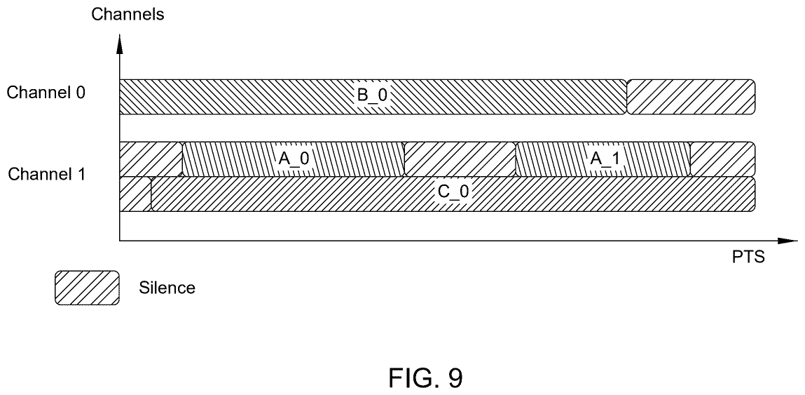

FIG. 9 is a block diagram depicting a resulting composition from the method of FIG. 8 applied to the timeline and events (tn) described with respect to FIG. 7. The resulting composition of a conference recording effectively showcases how individual streams from participants are synchronized and integrated into a final dual-channel recording. This visualization illustrates the complex process of aligning multiple audio tracks that have been recorded at different times during a conference call.

The timeline begins with the initiation of the conference and sequentially marks the entry and exit points of each participant.

As the conference progresses, the individual streams—each with its own set of metadata including timestamps—are processed. The system uses these timestamps to align the streams accurately, ensuring that the audio plays back in the same sequence and timing as the original conversation. This alignment may be important, especially in scenarios where participants respond to each other in real-time, as it preserves the natural flow of dialogue.

The final composition phase is depicted towards the end of the timeline. Here, the aligned streams are merged into a dual-channel format. Typically, one channel might be designated for a specific participant or a group of participants, while the other channel contains the combined audio of the remaining participants. This method of separation can be particularly useful for applications like transcription or detailed analysis, where isolating individual speakers may be necessary.

Additional processing steps may be applied during the composition phase, such as noise reduction, volume normalization, or other audio enhancements. These processes improve the clarity and quality of the final recording.

### Transition Plan to Multi-Channel Recordings/Recordings

Multi-channel recordings involve capturing and storing audio from each source or participant on separate tracks or channels, allowing for individual adjustments and processing. This method may be used in professional environments like music production, film, and sophisticated conferencing systems, where clarity and control over each audio input are crucial. Dual-channel recordings, or stereo recordings, are a specific type of multi-channel recording that uses exactly two channels, typically to create a sense of spatial audio directionality—left and right. This mimics the natural human hearing experience and is common in everyday audio applications such as music and television.

Dual-channel recording is essentially a subset of multi-channel recording, where the latter can involve any number of channels, where the latter can involve any number of channels, where each channel could represent an individual conference participant's audio stream. Therefore, systems capable of handling multi-channel recordings can inherently manage dual-channel recordings, but not all systems designed for dual-channel can handle multi-channel complexities.

Transitioning from dual to multi-channel recording involves scaling up the system to handle more audio channels simultaneously, which increases both the system's complexity and its range of applications.

In conferencing, for example, dual-channel recordings might separate the audio of two main speakers or differentiate between a speaker and background noise. Multi-channel recordings extend this capability by capturing each participant's audio on separate channels, enhancing post-meeting processing like transcription, where isolating each speaker can significantly improve clarity and accuracy. Thus, moving from dual-channel to multi-channel recording marks a significant upgrade in audio processing technology, catering to environments that demand high-level audio editing and mixing capabilities.

The method of forking may be reused by multi-channel recordings. All of the changes required for forking may be re-used by multi-channel conference recordings, as the system may still need to record individual participants'media streams.

With multi-channel, voice-recording-inflight-service may manage additional metadata inside the recording_sessions and recording_track resources. The recording_session resource can contain metadata about what tracks were involved, and the recording_track resource can contain participant metadata. Recording session and recording track resources will be exposed to the customer for multi-channel recordings.

For contextual participant data in the recording track resource, conference-state and voice-mixer-service may be configured to pass participant data to voice-recording-session-service which may tell voice-recording-inflight-service to save the contextual participant data along with the recording_track resource.

The composing logic in voice-recording-composition-service will be informed by the customer's recording configurations. There may be a separate service/API for customers to set their configurations (e.g., external S3, encryption, trimming, retention, etc.).

The Voice composer script may be reused to generate multi-channel output formats (.wav and .mka).

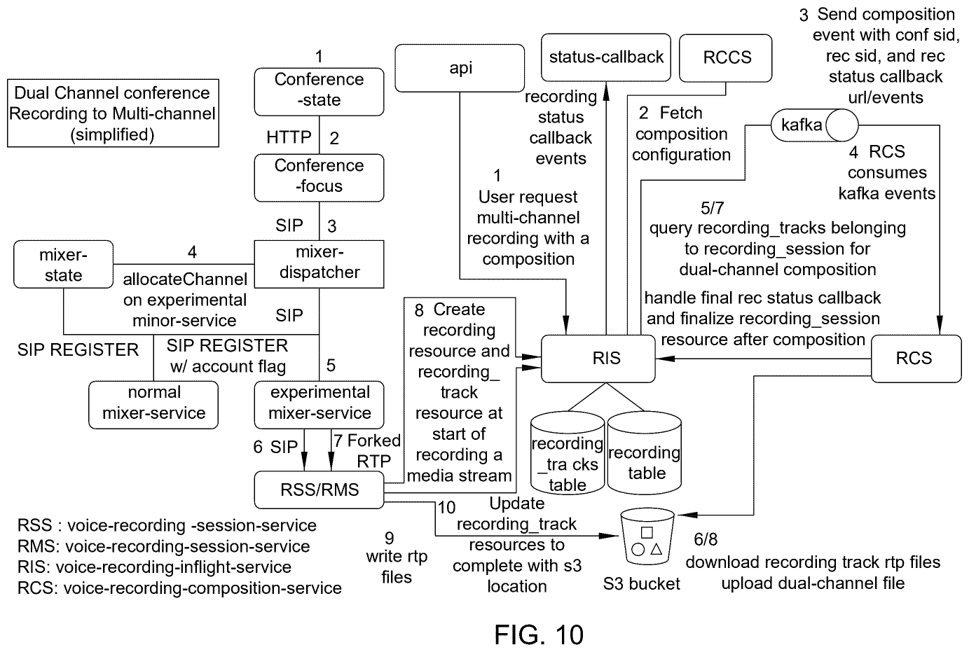

FIG. 10 is a block diagram outlining example architectural changes that may be implemented to transition from a dual-channel to a multi-channel recording system. This transition may involve enhancements to existing components and the introduction of new functionalities to manage and process multiple simultaneous streams effectively.

A part of the transition may include an enhancement of the mixer service, which is originally configured for dual-channel operations. The upgraded mixer service needs to handle multiple streams, routing each participant's input independently. This capability is used for maintaining the integrity of each stream, which is used for multi-channel recording where each channel may need to be processed and analyzed separately.

Alongside the mixer service, both the Recording Session Service (RSS) and the Recording Media Sink (RMS) are expanded to manage the increased data throughput and complexity. The RSS, which orchestrates the recording sessions, may now handle more intricate session logistics, tracking multiple streams and their associated metadata. The RMS, tasked with processing and initial storage of audio data, requires enhanced processing power and storage capabilities to manage the higher volume of data efficiently.

Another addition to the system is the advanced handling of Forked RTP streams. This process involves splitting each participant's stream at the mixer service and routing these streams to the RMS. Each stream is treated independently to preserve its unique characteristics, which is vital for subsequent processing and composition.

The Recording Composition Service (RCS) undergoes upgrades to compose the final audio product from these multiple streams. The RCS integrates sophisticated algorithms designed to synchronize and mix the streams accurately, ensuring the final recording mirrors the live interaction's dynamics. This service may be configured to be flexible enough to accommodate user-defined settings that influence the final output, such as audio level adjustments and stream prioritization.

Furthermore, the user interface is updated to allow explicit requests for multi-channel recordings and to enable users to specify detailed parameters for the recording composition. This enhancement improves user interaction, allowing for customized recording experiences tailored to specific needs.

The system architecture is designed for scalability and flexibility, anticipating future needs and potential expansions. This adaptability ensures that the system can evolve in response to emerging requirements and more complex conferencing scenarios that demand sophisticated audio processing capabilities.

### Example Mobile Device

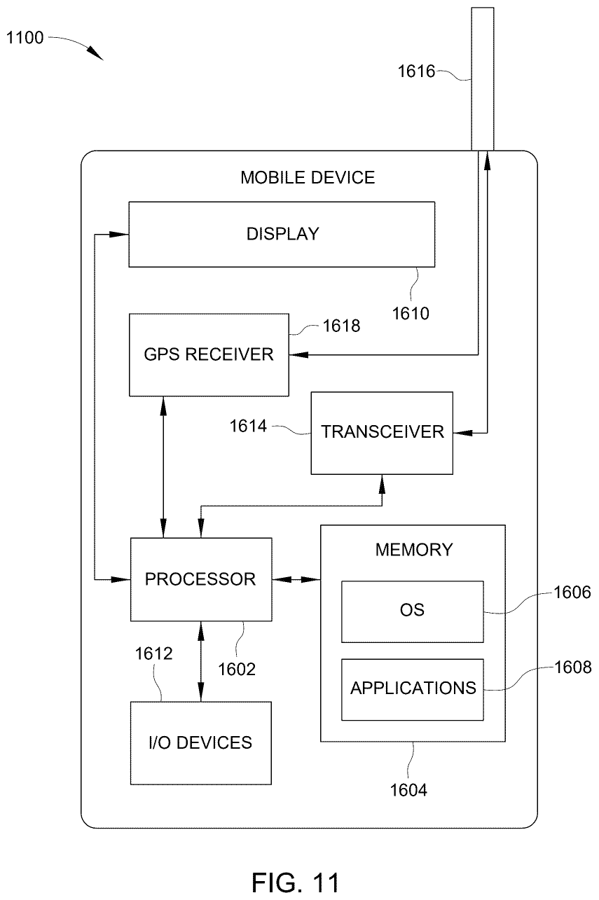

FIG. 11 is a block diagram illustrating a mobile device 1100, according to an example embodiment.

The mobile device 4300 can include a processor 1602. The processor 1602 can be any of a variety of different types of commercially available processors suitable for mobile devices 4300 (for example, an XScale architecture microprocessor, a Microprocessor without Interlocked Pipeline Stages (MIPS) architecture processor, or another type of processor). A memory 1604, such as a random access memory (RAM), a Flash memory, or other type of memory, is typically accessible to the processor 1602. The memory 1604 can be adapted to store an operating system (OS) 1606, as well as application programs 1608, such as a mobile location-enabled application that can provide location-based services (LBSs) to a user. The processor 1602 can be coupled, either directly or via appropriate intermediary hardware, to a display 1610 and to one or more input/output (I/O) devices 1612, such as a keypad, a touch panel sensor, a microphone, and the like. Similarly, in some embodiments, the processor 1602 can be coupled to a transceiver 1614 that interfaces with an antenna 1616. The transceiver 1614 can be configured to both transmit and receive cellular network signals, wireless data signals, or other types of signals via the antenna 1616, depending on the nature of the mobile device 4300. Further, in some configurations, a GPS receiver 1618 can also make use of the antenna 1616 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

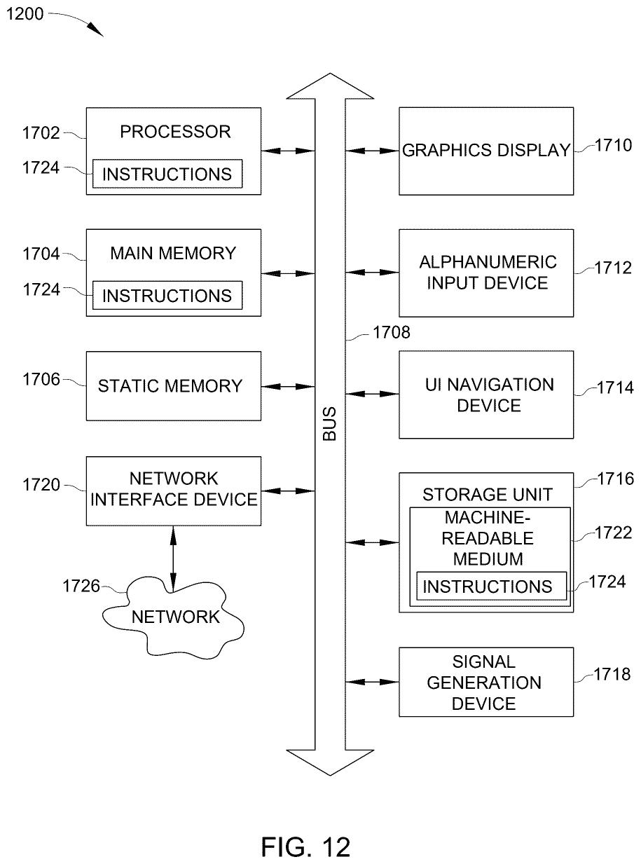

FIG. 12 is a block diagram of an example computer system 1200 on which methodologies and operations described herein may be executed, in accordance with an example embodiment.

In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 4400 includes a processor 1702 (e.g., a central processing unit (CPU), a graphics processing unit (GPU) or both), a main memory 1704 and a static memory 1706, which communicate with each other via a bus 1708. The computer system 4400 may further include a graphics display unit 1710 (e.g., a liquid crystal display (LCD) or a cathode ray tube (CRT)). The computer system 4400 also includes an alphanumeric input device 1712 (e.g., a keyboard or a touch-sensitive display screen), a user interface (UI) navigation device 1714 (e.g., a mouse), a storage unit 1716, a signal generation device 1718 (e.g., a speaker) and a network interface device 1720.

### Machine-Readable Medium

The storage unit 1716 includes a machine-readable medium 1722 on which is stored one or more sets of instructions and data structures (e.g., software) 1724 embodying or utilized by any one or more of the methodologies or functions described herein. The instructions 1724 may also reside, completely or at least partially, within the main memory 1704 and/or within the processor 1702 during execution thereof by the computer system 4400, the main memory 1704 and the processor 1702 also constituting machine-readable media.

While the machine-readable medium 1722 is shown in an example embodiment to be a single medium, the term “machine-readable medium” may include a single medium or multiple media (e.g., a centralized or distributed database, and/or associated caches and servers) that store the one or more instructions 1724 or data structures. The term “machine-readable medium” shall also be taken to include any tangible medium that is capable of storing, encoding or carrying instructions (e.g., instructions 1724) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1724 may further be transmitted or received over a communications network 1726 using a transmission medium. The instructions 1724 may be transmitted using the network interface device 1720 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more computer processors;
one or more computer memories;
a set of instructions stored in the one or more computer memories, the set of instructions configuring the one or more computer processors to perform operations, the operations comprising:
receiving one or more real-time communication streams from one or more participants in a conference;
independently forking each of the one or more real-time communication streams to a recording media sink configured to process and store the one or more real-time communication streams;
converting each of the one or more real-time communication streams into a format that encapsulates each stream with one or more metadata items, the one or more metadata items being usable for synchronizing the one or more real-time communication streams; and
making a multi-track recording accessible via an application programming interface (API) to one or more downstream tools for further processing or analysis at a conclusion of the conference, the multi-track recording composed by synchronizing the one or more real-time communication streams based on the one or more metadata items.

2. The system of claim 1, wherein the one or more metadata items include one or more timestamps indicating exact timing of each audio packet within each of the one or more real-time communication streams or one or more participant identifiers uniquely associating each of the one or more real-time communication streams with a corresponding participant.

3. The system of claim 2, wherein the synchronizing of the one or more real-time communication streams includes aligning audio from different participants according to a sequence of conversation events indicated by the one or more timestamps or the one or more participant identifiers.

4. The system of claim 1, wherein the composing of the multi-track recording includes detecting a specific audio event from the one or more metadata items, wherein the specific audio event includes a participant speaking while another participant is speaking, the participant starts speaking, or the participant stops speaking.

5. The system of claim 4, wherein the composing of the multi-track recording includes adding annotations identifying the specific audio event to facilitate enhanced analysis by the one or more downstream tools.

6. The system of claim 1, wherein the independently forking of each of the one or more real-time communication streams includes:
establishing a dedicated data path for each of the one or more real-time communication streams to ensure isolated handling and processing;
utilizing a forking mechanism that duplicates each of the one or more real-time communication streams upon receipt at a mixer service, directing one copy to ongoing live conference mixing and another copy to the recording media sink; and
maintaining separate processing queues for each forked stream at the recording media sink to prevent data loss and ensure integrity of recorded data.

7. The system of claim 1, wherein the synchronization of the one or more real-time communication streams includes:
aligning one or more timestamps to a unified timeline based on an earliest received audio packet among the one or more real-time communication streams;
adjusting a playback speed of individual streams to compensate for any discrepancies in audio packet arrival times, ensuring temporal consistency across the multi-track recording;
using metadata that includes participant identifiers to maintain a chronological order of speech contributions from each participant, ensuring that a sequence of conversation events is preserved.

8. A method comprising:
receiving one or more real-time communication streams from one or more participants in a conference;
independently forking each of the one or more real-time communication streams to a recording media sink configured to process and store the one or more real-time communication streams;
converting each of the one or more real-time communication streams into a format that encapsulates each stream with one or more metadata items, the one or more metadata items being usable for synchronizing the one or more real-time communication streams; and
making a multi-track recording accessible via an application programming interface (API) to one or more downstream tools for further processing or analysis at a conclusion of the conference, the multi-track recording composed by synchronizing the one or more real-time communication streams based on the one or more metadata items.

9. The method of claim 8, wherein the one or more metadata items include one or more timestamps indicating exact timing of each audio packet within each of the one or more real-time communication streams or one or more participant identifiers uniquely associating each of the one or more real-time communication streams with a corresponding participant.

10. The method of claim 9, wherein the synchronizing of the one or more real-time communication streams includes aligning audio from different participants according to a sequence of conversation events indicated by the one or more timestamps or the one or more participant identifiers.

11. The method of claim 8, wherein the composing of the multi-track recording includes detecting a specific audio event from the one or more metadata items, wherein the specific audio event includes a participant speaking while another participant is speaking, the participant starts speaking, or the participant stops speaking.

12. The method of claim 11, wherein the composing of the multi-track recording includes adding annotations identifying the specific audio event to facilitate enhanced analysis by the one or more downstream tools.

13. The method of claim 8, wherein the independently forking of each of the one or more real-time communication streams includes:
establishing a dedicated data path for each of the one or more real-time communication streams to ensure isolated handling and processing;
utilizing a forking mechanism that duplicates each of the one or more real-time communication streams upon receipt at a mixer service, directing one copy to ongoing live conference mixing and another copy to the recording media sink; and
maintaining separate processing queues for each forked stream at the recording media sink to prevent data loss and ensure integrity of recorded data.

14. The method of claim 8, wherein the synchronization of the one or more real-time communication streams includes:
aligning one or more timestamps to a unified timeline based on an earliest received audio packet among the one or more real-time communication streams;
adjusting a playback speed of individual streams to compensate for any discrepancies in audio packet arrival times, ensuring temporal consistency across the multi-track recording;
using metadata that includes participant identifiers to maintain a chronological order of speech contributions from each participant, ensuring that a sequence of conversation events is preserved.

15. A non-transitory computer-readable storage medium storing a set of instructions that, when executed by one or more computer processors, causes the one or more computer processors to perform operations, the operations comprising:
receiving one or more real-time communication streams from one or more participants in a conference;
independently forking each of the one or more real-time communication streams to a recording media sink configured to process and store the one or more real-time communication streams;
converting each of the one or more real-time communication streams into a format that encapsulates each stream with one or more metadata items, the one or more metadata items being usable for synchronizing the one or more real-time communication streams; and
making a multi-track recording accessible via an application programming interface (API) to one or more downstream tools for further processing or analysis at a conclusion of the conference, the multi-track recording composed by synchronizing the one or more real-time communication streams based on the one or more metadata items.

16. The non-transitory computer-readable storage medium of claim 15, wherein the one or more metadata items include one or more timestamps indicating exact timing of each audio packet within each of the one or more real-time communication streams or one or more participant identifiers uniquely associating each of the one or more real-time communication streams with a corresponding participant.

17. The non-transitory computer-readable storage medium of claim 16, wherein the synchronizing of the one or more real-time communication streams includes aligning audio from different participants according to a sequence of conversation events indicated by the one or more timestamps or the one or more participant identifiers.

18. The non-transitory computer-readable storage medium of claim 15, wherein the composing of the multi-track recording includes detecting a specific audio event from the one or more metadata items, wherein the specific audio event includes a participant speaking while another participant is speaking, the participant starts speaking, or the participant stops speaking.

19. The non-transitory computer-readable storage medium of claim 18, wherein the composing of the multi-track recording includes adding annotations identifying the specific audio event to facilitate enhanced analysis by the one or more downstream tools.

20. The non-transitory computer-readable storage medium of claim 15, wherein the independently forking of each of the one or more real-time communication streams includes:
establishing a dedicated data path for each of the one or more real-time communication streams to ensure isolated handling and processing;
utilizing a forking mechanism that duplicates each of the one or more real-time communication streams upon receipt at a mixer service, directing one copy to ongoing live conference mixing and another copy to the recording media sink; and
maintaining separate processing queues for each forked stream at the recording media sink to prevent data loss and ensure integrity of recorded data.
